(19) United States
(12) Patent Application Publication
(10) Pub. No.: US 2013/0299639 A1
(43) Pub. Date: Nov. 14, 2013

(54) Communication System

(71) Applicant: EADS CONSTRUCCIONES AERONAUTICAS, S.A., Getafe Madrid (ES)

(72) Inventor: Bruno Martinez Vazquez, Madrid (ES)

(73) Assignee: EADS Construcciones Aeronauticas, S.A., Getafe Madrid (ES)

(21) Appl. No.: 13/891,748

(22) Filed: May 10, 2013

(30) Foreign Application Priority Data
May 10, 2012 (ES) 201230703

(51) Int. Cl. B64D 39/00

(52) U.S. Cl. CPC B64D 39/00
USPC 244/135 A

(57) ABSTRACT

A communications system between a receiving aircraft and a tanker aircraft. The system includes a retractable tube with a nozzle which connects to a receiving aircraft receptacle, wherein the system comprises a primary device for sending/receiving data on the nozzle and a secondary device for sending/receiving data on the receptacle. The tanker and receiving aircraft transmit data by means of the devices only when the devices are both active and positioned opposite each other. In this way an indication is enabled to at least one of the two aircraft that the nozzle is correctly connected in the receptacle.

### CROSS-REFERENCES TO RELATED APPLICATIONS

This application claims the benefit of the Spanish patent application No. 201230703 filed on May 10, 2012, the entire disclosures of which are incorporated herein by way of reference.

### FIELD OF THE INVENTION

This invention refers to a communications system used during in-flight refueling of aircraft, between a tanker aircraft and a receiving aircraft.

### BACKGROUND OF THE INVENTION

For in-flight refueling operations, a known method is based on the use of a retractable tube device, commonly called a boom, intended for connecting a supply aircraft or tanker aircraft with a receiving aircraft, in flight. This device basically consists of a telescopic tube which is fitted to the bottom of the tanker aircraft by means of a joint unit, further comprising, at the other end a fuel feed nozzle by means of which the fuel passes to the receiving aircraft. This fuel feed nozzle connects to a receptacle in the receiving aircraft to make a proper the fuel transfer between the two aircraft.

The refueling operation requires that the receiving aircraft be in a precise and consistent position prior to the contact and at the contact itself. Therefore, reliable and precise communications need to be established between the receiving and tanker aircraft, by means of an appropriate communications system.

Equally fundamental during the in-flight refueling operation is detecting the moment that contact occurs between the two aircraft.

As such, the current communications system in in-flight refueling operations is based on two induction coils, one located in the tanker aircraft boom nozzle and the other in the receiving aircraft receptacle, such that the two coils, in the nozzle and receptacle, face each other when contact occurs between the two aircraft, such that circulation of connection pulses and audio data between said coils are enabled, defining the connection status between the two aircraft. Said known communications systems have been used since the first refueling aircraft developed in the nineteen-forties/fifties and have not undergone changes or seen progress in recent decades.

The problem posed by the known communications systems is that they are not as reliable as would be considered appropriate as they are based on induced, rather than direct, values. Additionally, the data transmitted between the two aircraft via audio can suffer distortion that would lead to creating hazardous situations in refueling operations.

Thus, in current communications systems, the indications of connection status between the nozzle and the receptacle take place by means of induced values in the two coils, in the receptacle coil (receiving aircraft) and the nozzle coil (tanker aircraft boom), in a similar manner to signals induced between the primary and secondary in a power transformer. A change in status of the refueling system occurs according to the receipt of a series of pulses. These pulses can be generated either by the receiving aircraft or the tanker aircraft.

However, in addition to knowing whether or not the nozzle is connected to the receptacle, it is also of interest to transfer other series of relevant data between the receiving and tanker aircraft. In this, the known communications systems also comprise an audio system which is responsible for transferring oral communications between the receiving aircraft's pilot and the tanker aircraft's refueling systems operator.

A limitation of the above system is that all communications take place orally, without the possibility of transmitting signals or information automatically which would improve information security, hence these systems can lead to erroneous or misunderstood communications, incorrect synchronization, etc.

However, radio frequency emissions (radio link, Wi-Fi, etc.) have the disadvantage that emissions of this type can also be detected by other aircraft or in certain control posts.

The present invention is intended to overcome the problems and disadvantages described above.

### SUMMARY OF THE INVENTION

As such, this invention develops a communications system used in in-flight refueling of aircraft, in particular the in-flight refueling of a receiving aircraft using a tanker aircraft.

The communications system of the invention comprises a primary device for sending/receiving data on the nozzle of the retractable tube or boom of the tanker aircraft which connects to a secondary device for sending/receiving data on the receptacle of the receiving aircraft, such that said communications system transmits data only when the nozzle on the tanker aircraft retractable tube or boom and the receiving aircraft receptacle are connected to each other, i.e., only when the primary device for sending/receiving data on the retractable tube nozzle or boom and the secondary device for sending/receiving data on the receiving aircraft receptacle are facing each other and are also active or activated. In this way, the communications system of the invention provides the certainty that, when the fuel transfer operation between the tanker and receiving aircraft begins, the tanker aircraft nozzle is indeed connected in the receiving aircraft receptacle.

The communications system developed by the invention transmits data by means of digital signals, rather than the analog signals in the background technology, making these communications more reliable and robust. Furthermore, its construction is compatible with relative rotations between the tanker aircraft and the receiving aircraft. In the previous known technique, as described in background above, the receiving aircraft and tanker aircraft coils, i.e., in the receptacle and boom, need to be perfectly aligned faced each other for the data transmission to be correct. If the two coils had a relative displacement, data transmission would continue, although this transmission would not be correct. In the case of relative rotation between the tanker and receiving aircraft, the boom and receptacle coils would not be perfectly aligned opposite each other, thus the system using the previous technique would not be compatible with these relative displacements. However, the communications system developed by the invention, as it transmits data using digital signals of 0 s or 1 s, eliminates erroneous or defective transmissions, at the same time as being a system compatible with relative rotations between the two aircraft.

### BRIEF DESCRIPTION OF THE DRAWINGS

The following objects and many of the advantages of this invention can be appreciated more easily though a basic understanding of the details described above, in combination with the more detailed description that appears below along with the accompanying figures, where:

FIG. 1 shows a general outline of an in-flight refueling operation between a tanker aircraft and a receiving aircraft using the retractable tube or boom technique.

FIG. 2 shows a diagram of an in-flight refueling nozzle using the tanker aircraft retractable tube or boom technique in a communications system used in the refueling of aircraft using the background previously known technique.

FIG. 3 shows an outline of an in-flight refueling nozzle using the tanker aircraft retractable tube or boom technique in a communications system used in the refueling of aircraft using the disclosed invention, as well as the arrangement of the communications system in the receiving aircraft receptacle as per the disclosed invention.

FIG. 4 shows a diagram of the electronic configuration of a communications system used in aircraft refueling, as per the disclosed invention.

### DETAILED DESCRIPTION OF THE PREFERRED EMBODIMENTS

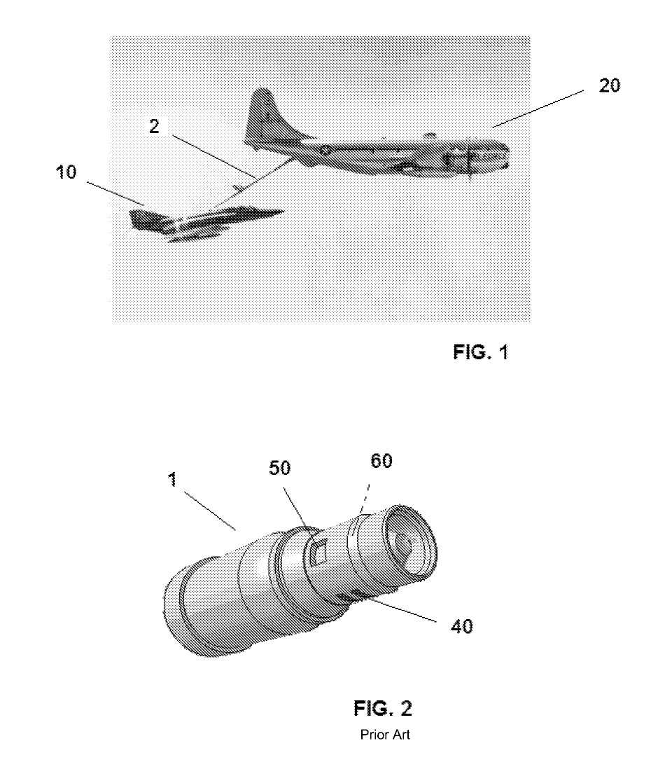

The invention develops a communications system used in in-flight refueling of aircraft, in particular the in-flight refueling of a receiving aircraft 10 by means of a tanker aircraft 20 as per the general arrangement shown in FIG. 1.

The communications system of the invention comprises a primary device for sending/receiving data 201 on the nozzle 1 of the tanker aircraft 20 retractable tube or boom 2 and a secondary device for sending/receiving data 202 on the receiving aircraft 10 receptacle 3.

The communications system of the invention only transmits data when the nozzle 1 of the tanker aircraft 20 retractable tube or boom 2 and the receiving aircraft 10 receptacle 3 are connected, with the primary device for sending/receiving data 201 on the nozzle 1 and the secondary device for sending/receiving data 202 on the receptacle 3 perfectly aligned opposite each other as well as both devices 201 and 202 being active, or at least the two devices substantially opposite each other such that data transmission is possible. That is, the primary device for sending/receiving data 201 and the secondary device for sending/receiving data 202 are sufficiently well aligned facing each other and therefore permitting data transmission providing that the nozzle 1 is in a certain position or within a limited range of positions within the receptacle 3 (previously determined and defined positions such that the connection of the nozzle 1 in the receptacle 3 is such as to permit the function it is to perform, in particular the in-flight transfer of fuel between the two aircraft, 10 and 20). This indicates that the two aircraft 10, 20, are in the correct relative contact position, as this contact position is used for a dry training and maneuvering contact without fuel transfer or as an indication that marks approval to begin the operation to transfer fuel between the two aircraft, 10 and 20. This provides certainty that, when the operation between the tanker 20 and receiving aircraft 10 begins, the nozzle 1 is really connected in the receiving aircraft 10 receptacle 3.

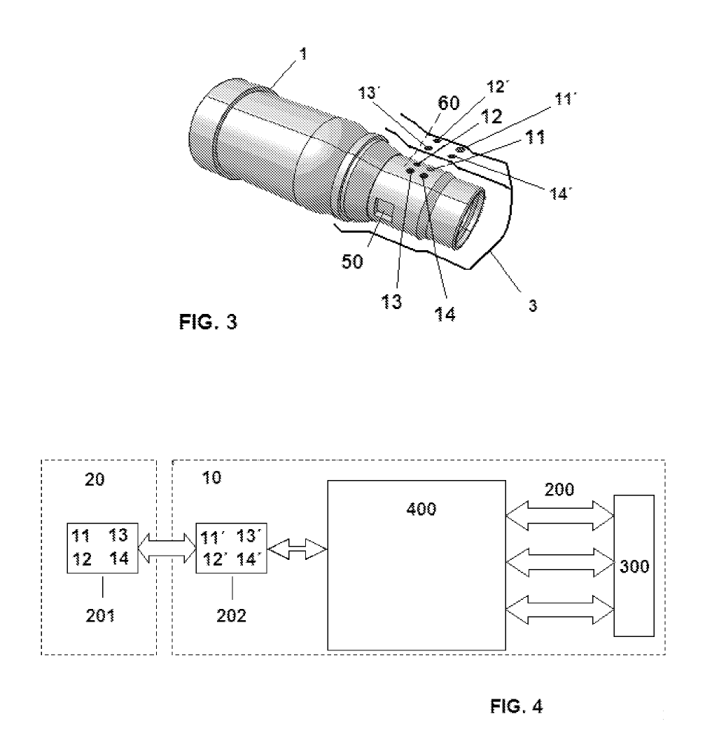

The communications system of the invention operates with direct, rather than induced, signals between the primary device for sending/receiving data 201 and the secondary device for sending/receiving data 202 once the receiving 10 and tanker aircraft 20 are connected. Hence, the primary device for sending/receiving data 201 on the nozzle 1 and the secondary device for sending/receiving data 202 on the receptacle 3 preferably comprise infra-red communication components such as infra-red senders/receivers, preferably one infra-red sender 11 and three infra-red receivers 12, 13, 14 on the nozzle 1 (FIG. 3) and three infra-red senders 12′, 13′, 14′ and one infra-red receiver 11′ on the receptacle 3 facing the aforementioned senders/receivers once the nozzle 1 is in the correct position inside the receptacle 3, such that the connection of the receiving 10 and tanker aircraft 20 is correct and secure.

In the background of the invention, represented in FIG. 2, the nozzle 1 comprises an induction coil 40 which is positioned opposite another induction coil (not represented) located on the receptacle 3. In general, the induction coil 40 needs to be at the bottom of the nozzle 1, as shown in FIG. 2, such that some latches 50, 60 (see FIG. 2) are arranged at 90° with respect to this coil 40, thereby achieving correct connection between the nozzle 1 and the receptacle 3. The change of system status of the aforementioned background of the invention occurs according to the receipt of a series of pulses passing through the nozzle 1 induction coil 40 and the receptacle 3 induction coil, where these pulses can be generated both by the receiving aircraft 10 and the tanker aircraft 20. On each pulse, the background of the invention system toggles from the free flight status to coupled flight status and then back to free flight status again.

The communications system of the currently disclosed invention preferably comprises, as represented in the outline in FIG. 3, and as described, one infra-red sender 11 and three infra-red receivers 12, 13, 14 on the nozzle 1, facing the corresponding ones on the receptacle 3, where said four infra-red senders/receivers 11, 12, 13, 14 are arranged on the top of the nozzle 1, at 90° with respect to some latches 50, 60 by means of which the nozzle 1 is clamped to the receptacle 3, with both in a specific position, such that the nozzle 1 senders/receivers 11, 12, 13, 14 and the receptacle 3 senders/receivers 11′, 12′, 13′, 14′ are opposite each other. In this way, with the communications system of the invention, the certainty that data is transmitted only when the nozzle 1 and the receptacle 3 are perfectly connected is achieved, as only then are the aforementioned senders/receivers opposite each other and receiving and sending data between them.

As represented in FIG. 3, of the four infra-red senders/receivers arranged on the tanker aircraft 20 nozzle 1, the infra-red sender labeled 11 and the infra-red receiver labeled 12 (with the corresponding receptacle 3 infra-red receiver 11′ and the corresponding infra-red sender 12′), would be responsible for transmitting information on the existence of contact between the nozzle 1 and the receptacle 3 (i.e., the datum that the nozzle 1 is in the appropriate position in the receptacle 3), with this information transmitted to the tanker aircraft 20 (by means of infra-red receiver 12) and the receiving aircraft 10 (by means of receiver 11′). Two infra-red receivers on the nozzle 1, labeled 13 and 14 (with the corresponding senders 13′ and 14′ on the receptacle 3), would be responsible for transmitting the data buses between the tanker 20 and receiving aircraft 10, as detailed below. By means of the senders/receivers 13, 14, 13′ y 14′, it is possible to separate the functions of the data transmitted between the tanker 20 and receiving aircraft 10, so that the communications system of the invention has greater reliability as it is a redundant system.

The attached Table I presents the configuration scheme for the infra-red senders/receivers 11, 12, 13 and 14 arranged on the nozzle 1, represented in FIG. 3, as well as that for the infra-red senders/receivers 11′, 12′, 13′ and 14′ arranged on the receptacle 3:

TABLE I

| Sender/ | Tanker Aircraft | Receiving Aircraft | Signals |
|---|---|---|---|
| Receiver | 20 | 10 | Sender/Receive |
| 11/11′ | Sender (11) | Receiver (11′) | Aircraft 10, 20 |
| | | | connected |
| | | | Signal transmitted to |
| | | | receiving aircraft 10 |
| 12/12′ | Receiver (12) | Sender (12′) | Aircraft 10, 20 |
| | | | connected |
| | | | Signal transmitted to |
| | | | tanker aircraft 20 |
| 13/13′ | Receiver (13) | Sender (13′) | Data bus |
| 14/14′ | Receiver (14) | Sender (14′) | |

The functional arrangement of the configuration shown in FIG. 3 and included in Table I above in turn is as follows:

the information that the aircraft 10, 20 are connected is transmitted through the sender 11 and receiver 11′, said information reaching the receiving aircraft 10 through receiver 11′;

the information that the aircraft 10, 20 are connected is transmitted through the sender 12 and receiver 12′, said information reaching the tanker aircraft 20 through the receiver 12;

data buses of information are transmitted between the tanker 20 and receiving aircraft 10 by means of the receivers 13, 14 and the senders 13′, 14′, with this information being functionally redundant and separated, so as to provide the system with greater reliability.

The embodiment presented previously (FIG. 3) is one of those possible embodiments for the communications system of the disclosed invention. However, the system of the invention can have other possible embodiments: comprising at least one sender 11 on the nozzle 1 and one receiver 11′ on the receptacle 3; also comprising one receiver 12 on the nozzle 1 and one sender 12′ on the receptacle 3; or also comprising receivers 13, 14 and senders 13′, 14′.

The attached Table II presents the operating protocol for the contact signals in the communications system of the present invention, taking into account that, as shown in FIG. 3, the contact signals between the nozzle 1 and the receptacle 3 are sent by means of the sender 11 and receiver 12 on the nozzle 1 and by means of the receiver 11′ and sender 12′ on the receptacle 3:

TABLE II

| Sender/Receiver | Sender/Receiver | |
|---|---|---|
| 11, 12 | 11′, 12′ | Nozzle/receptacle status |
| Off | Off | Contact not established |
| On | Off | The aircraft 10, 20 are in contact; |
| | | the tanker aircraft 20 notifies its |
| | | situation to the receiving aircraft |
| | | 10, which has still not changed |
| | | status |
| Off | On | The aircraft 10, 20 are in contact; |
| | | the receiving aircraft 10 notifies its |
| | | situation to the tanker aircraft 20, |
| | | which has still not changed status |
| On | On | Contact has been established and |
| | | the receiving 10 and tanker aircraft |
| | | 20 have changed status |

The attached Table III presents the data transmission arrangement (transmitted digitally, as can be seen in the attached table) between the tanker 20 and receiving aircraft 10, such that, by means of the infra-red senders 13′ and 14′, the receiving aircraft 10 sends information on its status to the tanker aircraft 20 via its infra-red receivers 13, 14:

TABLE III

| Receiver 13, 14 | Sender 13′, 14′ | |
|---|---|---|
| Tanker Aircraft 20 | Receiving Aircraft 10 | Status |
| Off | Off | Contact not established |
| On | Off | BIT 0 |
| Off | On | BIT 1 |
| On | On | Invalid status |

As described previously, the data buses transmitted between the receiving aircraft 10 and the tanker aircraft 20 would be those shown below:

Receiving aircraft 10 identification: type of receiving aircraft 10 connected and registration or unique identifier of the receiving aircraft 10;

Speeds/accelerations of the receiving aircraft 10 in its six axes, enabling a load relief mode to be effected at the tip of the boom when connected based on information provided by the receiving aircraft 10, instead of by measuring the forces occurring in the tip of the retractable tube or re-fuelling boom;

Receiving aircraft 10 fuel tanks level, as well as overfill valve condition, which makes it possible to know when the receiving aircraft 10 filling is finishing so as to reduce the supply flow rate from the tanker aircraft 20 to the receiving aircraft 10, so reducing the pressure peaks in the fuel supply operation.

The communications system developed by the present invention also develops an electronic apparatus 400 which collects the information transmitted to systems 300 in the receiving aircraft 10, transforming this information by means of a selected protocol 200. As such, the electronic apparatus 400 in the receiving aircraft 10 collects the data coming from the secondary device for sending/receiving data 202, transforming this data by means of a selected protocol 200 and sending them to the systems 300 in the receiving aircraft 10. The block diagram showing the operating schema for this electronic apparatus is shown in FIG. 4. A specific electronic apparatus may likewise be developed in the tanker aircraft 20 or the control systems for the retractable tube or boom may be permitted to assume these functions.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. A communications system between a receiving aircraft and a tanker aircraft comprising:
a retractable tube with a nozzle which connects to a receiving aircraft receptacle,
wherein said system comprises a primary device for sending/receiving data on the nozzle and a secondary device for sending/receiving data on the receptacle,
such that the tanker and receiving aircraft transmit data by means of said devices only when said devices are both active and positioned opposite each other,
such that an indication is enabled to at least one of the two aircraft that the nozzle is correctly connected in the receptacle.

2. The communications system of claim 1, wherein the primary device for sending/receiving data and the secondary device for sending/receiving data each comprise an infrared communication component comprising at least one of infra-red senders and receivers.

3. The communications system of claim 2, including at least one infra-red sender in the primary device for sending/receiving data and at least one infra-red receiver in the secondary device for sending/receiving data.

4. The communications system of claim 2, including at least one infra-red sender in the secondary device for sending/receiving data and at least one infra-red receiver in the primary device for sending/receiving data.

5. The communications system of claim 2 comprising an infra-red sender and an infra-red receiver in the primary device for sending/receiving data on the nozzle and an infra-red sender and an infrared receiver in the secondary device for sending/receiving data on the receptacle, so as to permit indication to both aircraft that the nozzle is correctly connected in the receptacle.

6. The communications system of claim 1, wherein the data transmitted by means of the primary and secondary devices comprises information on a status of at least one of the receiving aircraft and the tanker aircraft.

7. The communications system of claim 2, wherein the data transmitted by means of the primary and secondary devices comprises information on a status of at least one of the receiving aircraft and the tanker aircraft.

8. The communications system of claim 2, including at least one additional infra-red receiver in one of the primary device and secondary device for sending/receiving data on the nozzle and the receptacle and at least one additional infra-red sender in the other of the primary device and secondary device for sending/receiving data on the nozzle and receptacle, so that the indication that the nozzle is correctly connected in the receptacle is transmitted by means of independent components.

9. The communications system of claim 7, including at least one additional infra-red receiver in one of the primary device and secondary device for sending/receiving data on the nozzle and the receptacle and at least one additional infra-red sender in the other of the primary device and secondary device for sending/receiving data on the nozzle and receptacle, so that the indication that the nozzle is correctly connected in the receptacle and the information on the status of at least one of the receiving aircraft and the tanker aircraft is transmitted by means of independent components.

10. The communications system of claim 2, wherein the infra-red communication component of the primary device for sending/receiving data is arranged on a top of the nozzle and the infra-red communication component of the secondary device for sending/receiving data is arranged in the receptacle so as to be faced to said infra-red communications component of the nozzle.

11. The communications system of claim 7, wherein the infra-red communication component of the primary device for sending/receiving data is arranged on a top of the nozzle and the infra-red communication component of the secondary device for sending/receiving data is arranged in the receptacle so as to be faced to said infra-red communications component of the nozzle.

12. The communications system of claim 8, wherein the infra-red communication component of the primary device for sending/receiving data is arranged on a top of the nozzle and the infra-red communication component of the secondary device for sending/receiving data is arranged in the receptacle so as to be faced to said infra-red communications component of the nozzle.

13. The communications system of claim 9, wherein the infra-red communication component of the primary device for sending/receiving data is arranged on a top of the nozzle and the infra-red communication component of the secondary device for sending/receiving data is arranged in the receptacle so as to be faced to said infra-red communications component of the nozzle.

14. The communications system of claim 1 further comprising an electronic apparatus in the receiving aircraft, such that this electronic apparatus collects the transmitted data to systems in the receiving aircraft, transforming this data by means of a selected protocol.

15. The communications system of claim 1, further comprising an electronic apparatus in the tanker aircraft, such that this electronic apparatus collects the transmitted data to systems in the tanker aircraft, transforming this data by means of a selected protocol.

16. The communications system of claim 1, wherein the communications system is designed such that it permits the transfer of fuel in flight between a receiving aircraft and a tanker aircraft.

17. An aircraft comprising the communications system of claim 1.
